(19) United States
(12) Patent Application Publication
(10) Pub. No.: US 2025/0310003 A1
(43) Pub. Date: Oct. 2, 2025

(54) POWER ADAPTATION FOR PON NETWORKS

(71) Applicant: ARRIS Enterprises LLC, Horsham, PA (US)

(72) Inventors: John Charles CHAMBERLAIN, Hickory, NC (US); Erik J. GRONVALL, Bloomington, MN (US); David BOWLER, Stow, MA (US); Barry D. COLELLA, Newburyport, MA (US)

(73) Assignee: ARRIS Enterprises LLC, Horsham, PA (US)

(21) Appl. No.: 18/863,169

(22) PCT Filed: Apr. 21, 2023
(86) PCT No.: PCT/US2023/019446

§ 371 Date: Nov. 5, 2024

Related U.S. Application Data
(60) Provisional application No. 63/338,612, filed on May 5, 2022.

(51) Int. Cl. H04B 10/80; H04B 10/272

(52) U.S. Cl. CPC H04B 10/808; H04B 10/272

(57) ABSTRACT

A power management system for an optical line terminal.

### CROSS REFERENCE TO RELATED APPLICATIONS

This application is a 371 National Stage Patent application claiming priority to International Patent Application No. PCT/US23/19446, filed Apr. 21, 2023, which claims the benefit of U.S. Provisional Patent Application Ser. No. 63/338,612 filed May 5, 2022.

### BACKGROUND

The subject matter of this application relates to power management for an OLT.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibers and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are broadcast to the feeder fiber 17.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

FIG. 2 illustrates wall power waveforms.

FIG. 3 illustrates telecommunication power waveforms.

FIG. 4 illustrates co-axial CATV power waveforms.

FIG. 5 illustrates a power circuit topology.

FIG. 6 illustrates a power selection technique.

FIG. 7 illustrates a fiber optical cable with conductors.

FIG. 8 illustrates an OLT and/or an ONT with a RF unit.

FIG. 9 illustrates an OLT with a battery backup.

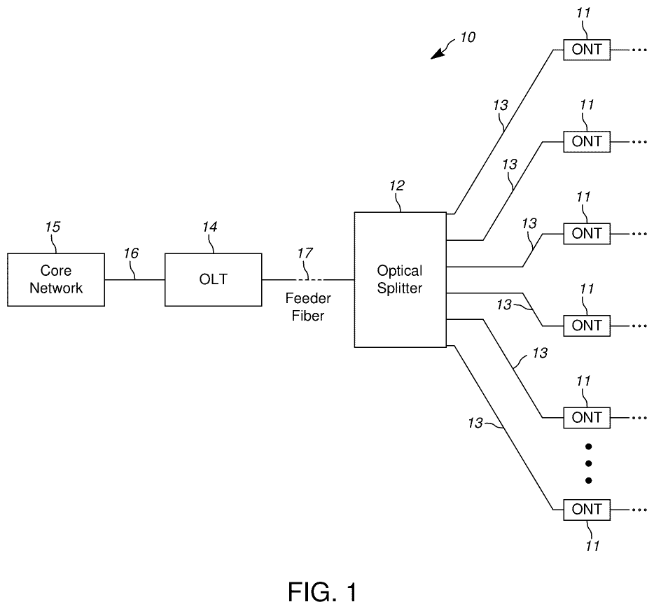

### DETAILED DESCRIPTION

Traditionally, the optical line terminals are maintained at the core network location which is typically a datacenter where they are interconnected to the core network with a suitable connection, such as a fiber optical cable, and the ONTs and other components are located outside the core network datacenter and are likewise interconnected to the optical line terminal. Each of the optical line terminals includes a power cord that is interconnected to the power at the core network through a power supply. By way of example, the power supply may convert an alternating current power source to a power level suitable for the optical line terminal. By way of example, the power supply may convert a direct current power source to a power level suitable for the optical line terminal. The power supplied to the optical line terminal at the core network typically has redundancies built in so that the likelihood of the power being interrupted is minimal.

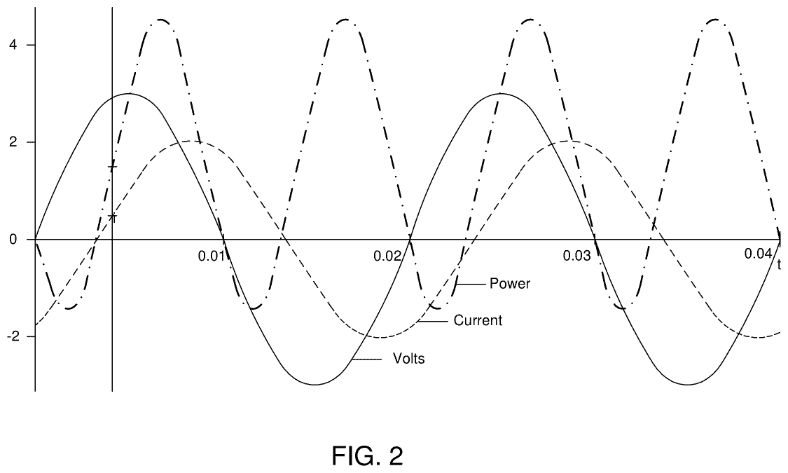

In some PON network configurations, the optical line terminals are located at locations remote to the core network, such as at various cabinets, vaults, or otherwise (generally referred to herein as a “node”) within the network itself. The fiber optic cables each include optical fibers that provide data connectivity between the core network and the respective optical line terminal. The optical line terminal is specifically designed to have its power supplied by a power cord and power supply for a particular type of power available. Referring to FIG. 2, often the power available at the remote location includes “wall power”, which is sinusoidal power signal at generally around 120 volts (e.g., 100 volts to 140 volts) at generally 60 hertz (e.g, 45 hertz to 75 hertz). Unfortunately, it is often difficult to route wall power to the optical line terminal, which may need to be routed from a remote location, such as a nearby telephone pole, a nearby utility power location, a nearby commercial facility, or otherwise.

While fiber optical cable that includes the optical fibers does not provide sufficient power to the optical line terminal for its operation, the node often includes other cabling because there are limited paths for cables to run from a central hub to the subscribers, typically limited to a series of telephone poles and underground conduits, shared among the different service providers of power and data connectivity (e.g., traditional phone service, coaxial cable networks, high voltage power distribution, or otherwise). For example, the node may also include active hybrid fiber coaxial cable connections with devices that are powered therein through the coaxial cable itself. For example, the node may also include active telecommunication connections with devices that are powered therein through the telecommunication wiring (e.g., twisted pairs of wires, such as 2 wires, 4 wires, 8 wires, etc.). However, the particular type of other cabling that any particular node includes varies from node to node. For example, some nodes may only have wall power available. For example, some nodes may only have coaxial power available. For example, some nodes may only have telecommunications power available. For example, some nodes may only have two of wall power, coaxial cable power, and telecommunications power available. In some cases, the node may have all three of wall power, coaxial cable power, and telecommunications power available.

Rather than designing three separate optical line terminals, each of which is specifically designed to work with one of the wall power, coaxial cable power, and telecommunications power, each of which needs to be inventoried by a service operator, it is preferable to include a single optical line terminal that works with two or three of the wall power, coaxial cable power, and telecommunications power.

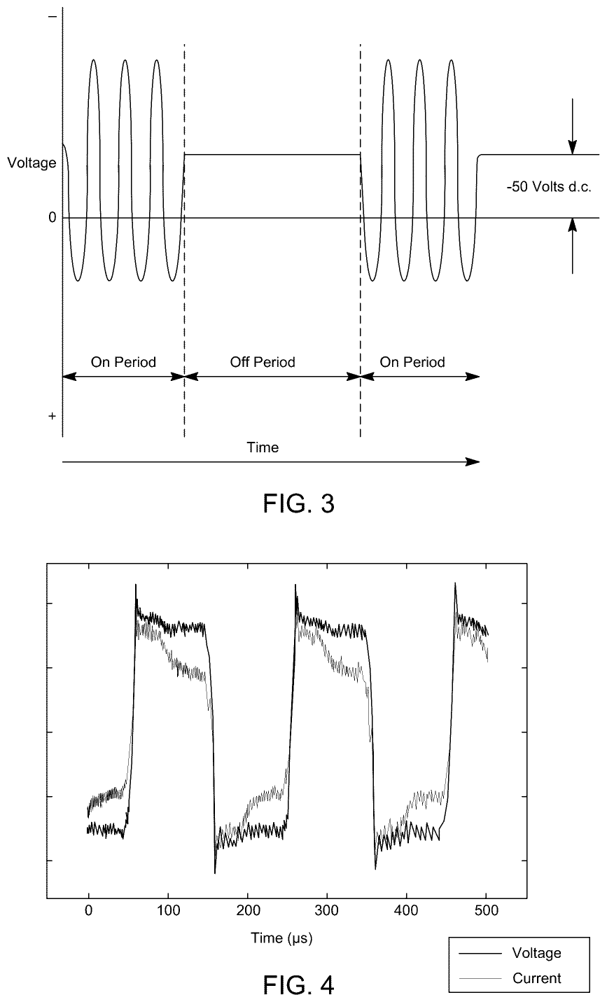

Referring to FIG. 3, the telecommunications power is based upon twisted pairs of wires, with a substantial number of such twisted pairs being included within a single cable. A pair of twisted wires from the wire bundle is selected to be used as the telecommunications power, where the selected twisted pair is arranged in a one-to-one relationship between the source power for the twisted pair and the optical line terminal. In other words, preferably the selected twisted pair does not provide power or other data (including voice) services to a subscriber. The twisted pair of wires typically provides −48 volts to −190 volts of direct current power (e.g., −125 volts to −20 volts), depending on the network configuration. Also, since the optical line terminal consumes electrical power, there is no need to include the capability of, or provide reverse power, back on the selected twisted pair of wires to the source.

Referring to FIG. 4, the coaxial cable power is based upon a quasi-sinusoidal power signal that is generally 60 volts to 90 volts (e.g., 45 volts to 115 volts) with generally 60 hertz (e.g, 45 hertz to 75 hertz). The quasi-sinusoidal power signal is provided down the core conductors of the coaxial cable, with the data signals superimposed therein at substantially higher frequencies.

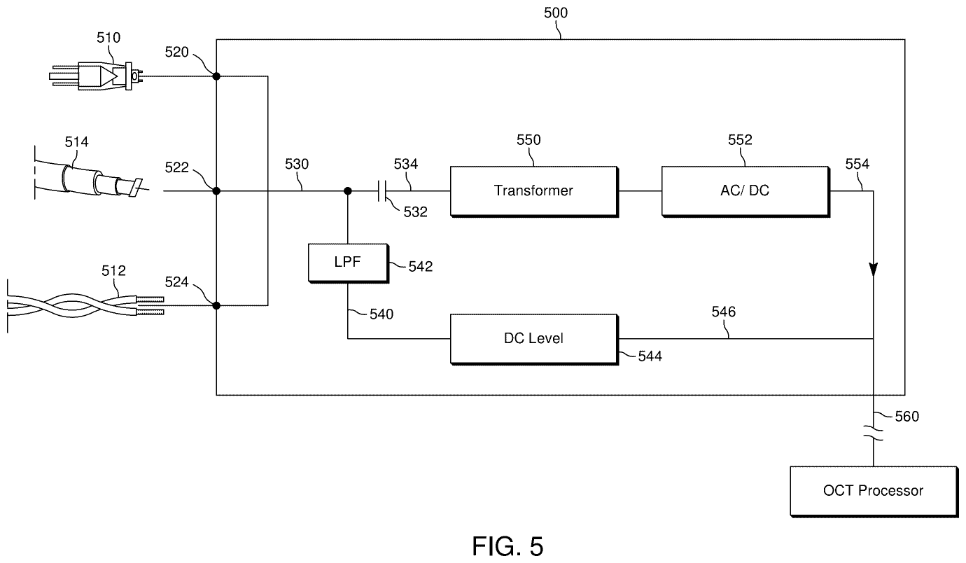

Referring to FIG. 5, an input power circuit topology 500 for the various types of potential power sources, namely, wall power 510, coaxial cable power 514, and telecommunications power 512, are illustrated. Each of the power sources is interconnected to a respective connector 520, 522, and 524 of the power circuit topology 500 of the optical line terminal. The input power circuit topology 500 may combine each of the power sources into a single line 530. The frequency of the wall power 510 and the coaxial cable power 514 are generally the same (within 10%), and superimposing wall power 510 and the coaxial cable power 514 results in a generally sinusoidal signal with a modified amplitude. The resulting generally sinusoidal signal 534 passes through a capacitor 532 which blocks direct current signals. The direct current signal from the telecommunications power 512 is blocked by the capacitor 532 and passes to a separate power path 540 which may be isolated from the alternating currents using a suitable AC block component 542, such as a low pass filter. The generally sinusoidal signal 534 is modified by a transformer 550 to provide a suitable output range, which is then modified by an AC to DC converter 552, resulting in a DC signal 554 suitable for the processor of the optical line terminal. The DC level of the separate power path 540 may be adjusted by a DC level circuit 544 to adjust the DC level resulting in a DC signal 546 suitable for the processor of the optical line terminal. Other circuit topologies may likewise be used, as desired.

The input power circuit topology 500 may auto-select among the various power sources, such that if one or more of the power sources is available, it will provide a suitable DC voltage for the operation of optical line terminal.

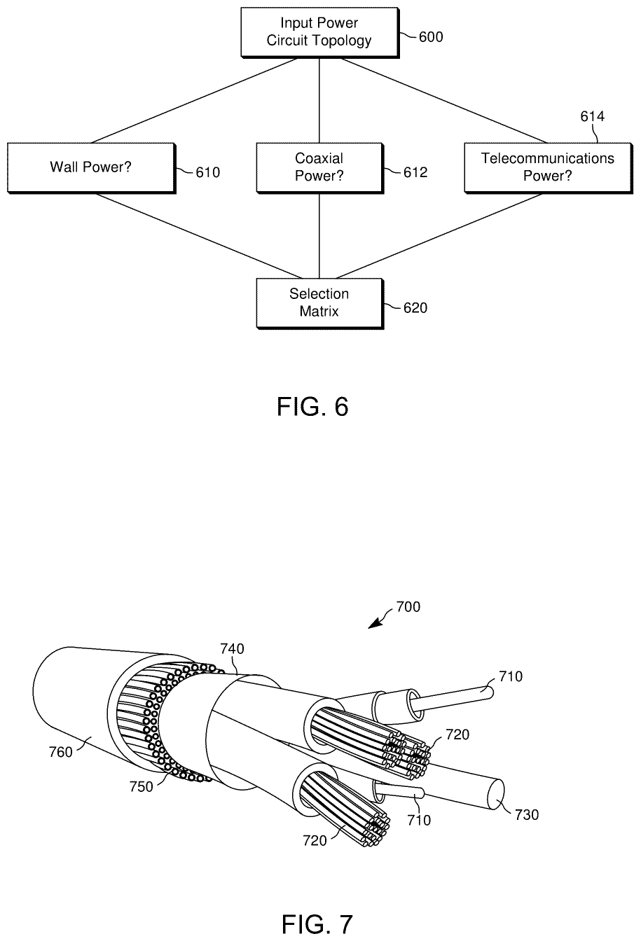

Referring to FIG. 6, the input power circuit topology may be modified to enable a hierarchical selection among the different power sources, among those that are available for a particular installation. The input power circuit topology 600 may determine which if the wall power 610, coaxial cable power 612, and/or telecommunications power 614 are available. A selection matrix 620 may be used to select which of the power sources 610, 612, 614 to used based upon which are available.

For example, if wall power 610, coaxial cable power 612, and telecommunications power 614 are available, the selection matrix 620 may select one of them as the first choice, then select another of them as the second choice in the event the first choice is subsequently unavailable, and then select the remaining one of them as the third choice in the event the first choice and the second choice are subsequently unavailable.

For example, if two of wall power 610, coaxial cable power 612, and telecommunications power 614 are available, the selection matrix 620 may select one of them as the first choice, then select another of them as the second choice in the event the first choice is subsequently unavailable.

For example, if only one of wall power 610, coaxial cable power 612, and telecommunications power 614 is available, the selection matrix 620 may select the one that is available, and then if it subsequently becomes unavailable there is no other power choice.

Preferably, the selection matrix is reprogrammable by the operator through configuration data provided to the optical line terminal.

Referring to FIG. 7, to provide added flexibility the fiber optical cable 700 may be modified to include one or more fiber bundles 710, insulated copper conductors 720, a central strength member 730, mylar tape 740, strength elements 750, and an outer jacket 760. One or more of the fiber bundles 710 is interconnected to the optical line terminal, and one or more of the copper conductors 720 may provide power to the optical line terminal. This modification enables the cable providing the optical data to also provide power to the optical line terminal.

The input power circuit topology 500 may be extended to include the fiber optical cable to provide power to the DC portion of the circuit and/or the AC portion of the circuit, depending on the particular type of power being provided by the copper conductors 720.

The input power circuit topology 600 may be extended to include the copper conductors 720 of the fiber optical cable 700, and extending the selection matrix 620 to further include the selection including the copper conductors 720.

Referring again to FIG. 5, the output power 560 provided to the circuitry of the optical line terminal should be referenced to the same ground potential as the digital circuitry of the optical line terminal. The ground reference of the telecommunications power is typically the higher potential conductor, with the other conductor being a negative potential to the higher potential conductor. The ground reference of the wall potential is normally referenced to a third conductor, with the other two conductors being the signal potential and a neutral potential. The ground reference of the coaxial cable power is normally referenced to the sheath around the conductor(s) of the coaxial cable. The circuit topology preferably modifies the ground reference of the respective signals so that the resulting ground reference provided to the digital electronics of the optical line terminal are referenced to the same (or substantially the same) value.

With the power flexibility provided by the modified optical line terminal, a single device may be used for a variety of different installation environments.

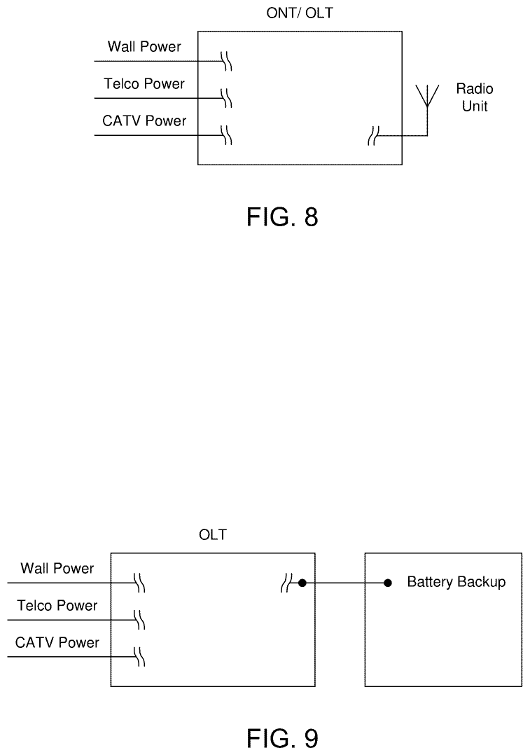

Referring to FIG. 8, an optical line terminal and/or an optical network terminal may include a plurality of separate power sources, as previously described. With the power being supplied to the optical line terminal and/or an optical network terminal an associated radio unit may likewise be supplied power from the same power sources through the optical line terminal and/or an optical network terminal. The associated radio unit provides wireless communication to one or more subscribers. For example, the wireless communication of the radio unit may be, Wi-Fi 5 (802.11ac), Wi-Fi 6 (802.11ax).

Referring to FIG. 9, if desired, the optical line terminal may include an associated battery backup system. The battery backup provides power to operate the optical line terminal in the event that the power is interrupted to the optical line terminal. Also, the optical line terminal also provides power to charge the associated battery backup system so that it may maintain a charged power level when power is being provided to the optical line terminal. Furthermore, the optical line terminal and/or the associated battery backup system may provide an alarm signal to the operator of whenever it is used to provide power to the optical line terminal. In this manner, the operator of the system may manage power outages and provide preventative maintenance, as desired.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An optical line terminal comprising:
(a) said optical line terminal capable of receiving digital data from a core network and in response provide optical digital data to a plurality of optical network terminals;
(b) said optical line terminal including a first connector suitable to receive sinusoidal wall power generally in the range of 100 volts to 140 volts at a frequency of 45 hertz to 75 hertz;
(c) said optical line terminal including a second connector suitable to receive quasi-sinusoidal power from a coaxial cable connection generally in the range of 45 volts to 115 volts at a frequency of 45 hertz to 75 hertz;
(d) said optical line terminal including a third connector suitable to receive direct current power from a twisted pair of wires;
(e) an input power circuit interconnected to said first connector, said second connector, and said third connector, where said input power circuit is configured to receive power from each of said first connector, said second connector, and said third connector and in response provide direct current power to a processor of said optical line terminal.

2. The optical line terminal of claim 1 wherein said twisted pair of wires does not provide power to any other device than said optical line terminal.

3. The optical line terminal of claim 1 wherein said frequency of said sinusoidal wall power and said frequency of said quasi-sinusoidal power are substantially the same.

4. The optical line terminal of claim 1 wherein direct current power to said processor of said optical line terminal is a combination of power received from at least two of said first connector, said second connector, and said third connector.

5. The optical line terminal of claim 1 wherein direct current power to said processor of said optical line terminal is a combination of power received from all three of said first connector, said second connector, and said third connector.

6. The optical line terminal of claim 1 wherein direct current power to said processor of said optical line terminal is a power received from one of said first connector, said second connector, and said third connector, and upon interruption of said power received, is received from another one of said first connector, said second connector, and said third connector.

7. The optical line terminal of claim 1 wherein direct current power to said processor of said optical line terminal is a power received from one of said first connector, said second connector, and said third connector, and upon interruption of said power received, is received from another one of said first connector, said second connector, and said third connector, and upon interruption of said power received from said another one of said first connector, said second connector, and said third connector is received from the remaining one of said first connector, said second connector, and said third connector.

8. The optical line terminal wherein a selection matrix is used to make a selection among said first connector, said second connector, and said third connector upon said interruption.

9. The optical line terminal of claim 1 wherein said direct current power from said input power circuit is provided to a radio unit interconnected with said optical line terminal.

10. The optical line terminal of claim 1 wherein said direct current power from said input power circuit is provided to a battery backup system interconnected to said optical line terminal.
